(19) United States
(12) Patent Application Publication
(10) Pub. No.: US 2009/0032059 A1
(43) Pub. Date: Feb. 5, 2009

(54) CLEANING MATERIAL AND METHOD OF CLEANING A SURFACE

(75) Inventors: SCOTT J. TUMAN, Woodbury, MN (US); Nathan A. Abel, White Bear Lake, MN (US); Daniel D. Anderson, Minneapolis, MN (US); Shaelyn D. Benson, Saint Paul, MN (US); Scott D. Gullicks, Apple Valley, MN (US); Byron E. Trotter, Saint Paul, MN (US); Lloyd S. Vasilakes, Stillwater, MN (US); Aaron J. Cherveny, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/833,697

(22) Filed: Aug. 3, 2007

(51) Int. Cl. B08B 7/00; A46B 9/02

(52) U.S. Cl. 134/9; 15/160

(57) ABSTRACT

A cleaning material, a cleaning tool and a method of cleaning a surface is disclosed. In one embodiment, a cleaning material comprises a backing including a first surface and a second surface, and an array of 20 to 1000 upstanding stems per square centimeter projecting from the first surface of the backing. Each stem has a height from 0.2 and 2.0 millimeters and a shore hardness less than 105 A. In one embodiment, the method of cleaning a surface comprises providing a cleaning material having an array of 20 to 1000 upstanding stems per square centimeter, wherein each stem has a height from 0.2 and 2.0 millimeters and a shore hardness less than 105 A, wiping the cleaning material over a surface to be cleaned, and capturing debris between the stems of the cleaning material.

### FIELD

The present disclosure relates to a cleaning material, a cleaning tool comprising a cleaning material, and a method of cleaning a surface. In particular the present disclosure relates to a cleaning material for gathering or removing debris, lint, or hair from a variety of surfaces, and a method of gathering or removing debris, lint, or hair from a surface.

### BACKGROUND

Adhesive or other tacky lint removal devices, such as lint rollers, or directional felted fabric, such as disclosed in U.S. Pat. No. 6,901,622 can be used to remove lint and debris, such as particles, dirt, or hair from a surface. Hair embedded into fabric surfaces presents a particular challenge to remove as the hair is often entangled into the fabric surface.

For adhesive lint removal devices, the adhesive may not be strong enough to capture strongly embedded hair. Also, even if the adhesive sheet can retain the hair, often the adhesive sheet becomes loaded with debris so quickly that it becomes inefficient to clean a large area or an area having heavy debris cover. For directional felted fabric, the fabric is only useful at removing debris, lint, or hair by use in one direction. Further, once the fabric becomes loaded with debris, the user must remove the debris to continue use as these types of materials are typically not disposable.

### SUMMARY

The present disclosure relates to a cleaning material for removing debris, lint, or hair from a variety of surfaces. It is understood that debris may includes a variety of loose contaminants on a surface, such as, for example, dirt, sand, food particles, crumbs, dander, fibers. In one embodiment, the cleaning material comprises a backing including a first surface and a second surface, and an array of 20 to 1000 upstanding stems per square centimeter projecting from the first surface of the backing, wherein each stem has a height from 0.2 and 2.0 millimeters and a shore hardness less than 105 A. The first surface comprising the stems is wiped over a surface to be cleaned to gather debris, lint, or hair.

The present disclosure relates to a cleaning tool for removing debris, lint, or hair from a surface to be cleaned. In one embodiment, the cleaning tool comprises a working surface including a continuously convexly curved lower face and an upper face converging to a tapered portion, a handle for holding the cleaning tool, and a cleaning material removably secured to at least a portion of the working surface.

In another embodiment, a cleaning tool for removing debris, lint, or hair comprises a working surface having a lower face and an upper face converging to a tapered portion, a cleaning material on at least a portion of the working surface, and a handle for holding the cleaning tool. The cleaning material comprises an array of 20 to 1000 upstanding stems per square centimeter, wherein each stem has a height from 0.2 and 2.0 millimeters and a shore hardness less than 105 A; and

The present disclosure relates to a method of cleaning a surface. In one embodiment, the method of cleaning a surface comprises providing a cleaning material having an array of 20 to 1000 upstanding stems per square centimeter, wherein each stem has a height from 0.2 and 2.0 millimeters and a shore hardness less than 105 A, wiping the cleaning material over a surface to be cleaned, and capturing debris between the stems of the cleaning material.

### BRIEF DESCRIPTION OF THE DRAWINGS

FIG. 1 is a perspective view of one embodiment of a cleaning material on a cleaning tool;

FIG. 2 is a side view of a cleaning material on a cleaning tool of FIG. 1;

FIG. 3 is a perspective view of another embodiment of a cleaning material on a cleaning tool;

FIG. 4 is a side view of an embodiment of a cleaning material;

FIG. 5 is a perspective view of a sheet of cleaning material;

FIG. 6 is a perspective view of another embodiment of a cleaning material.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

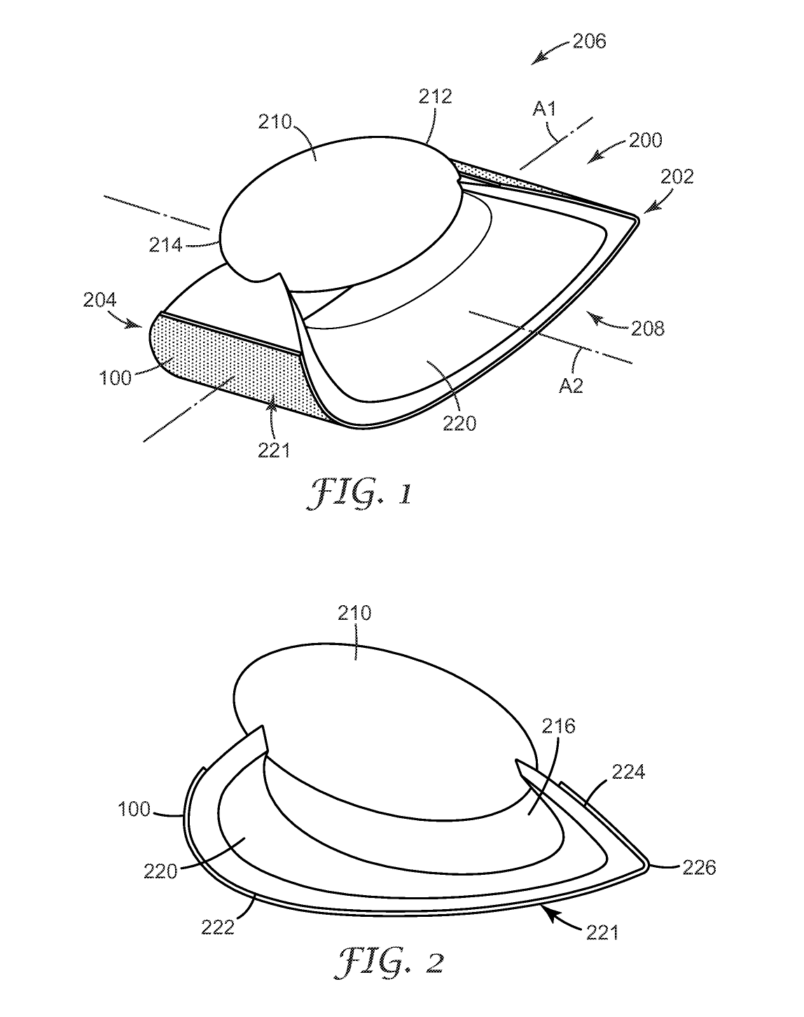

FIG. 1 is a perspective view of one embodiment of a cleaning material 100 that is attached to a cleaning tool 200. In particular, in this embodiment, the cleaning material 100 is a sheet that removably attaches to the cleaning tool 200. FIG. 2 is a side view of the cleaning material 100 and cleaning tool 200 of FIG. 1. The cleaning tool 200 includes a body 220, and in this embodiment the cleaning tool 200 includes an optional handle 210.

The body 220 of the cleaning tool 200 is shown oriented about a first axis A1 and second axis A1. The body 220 of the cleaning tool 200 has a first end 202, a second end 204 opposite the first end 202, a proximal region 206, in this embodiment referred to as an upper region, and a distal region 208, in this embodiment referred to as a bottom region. The body of the cleaning tool 200 includes a working surface 221. The working surface 221 supports the cleaning material 100 to make contact with the surface to be cleaned and perform the cleaning function.

In this embodiment, the working surface 221 includes convexly curved surface 222 and a top face 224. The convexly curved surface 222 extends along the direction of axis A1 from the body first end 202, to the body second end 204 and continues a curve around the body second end 204. It is understood that the curve of the convexly curved surface may have a single radius of curvature over the whole surface or may have a varying radius of curvature. The top face 224 extends from the body first end 202, however is generally opposite the convexly curved surface 222. In this embodiment, the top face 224 is a planar surface, however it may be curved (convex or concave), stepped, textured, irregular, or other shape or configuration. The top face 224 and convexly curved surface 222 converge together at the first end 202 of the cleaning tool 200 to form a tapered portion 226.

In the embodiment shown in FIGS. 1 and 2, the working surface 221 is generally not curved along the direction of axis A2. It is understood that the working surface may be curved (convex or convex), stepped, textured, irregular, or other shape or configuration in a direction along axis A2.

The cleaning tool 200 includes an optional handle 210 to provide a mechanism for a user to securely hold the cleaning tool. In this embodiment, the handle includes a first end 212 and a second end 214 that are integrally attached to the body 220 of the cleaning tool 200. Generally, the handle first end 212 is adjacent the top face 224 near the body first end 202, and the handle second end 214 is adjacent the convexly curved surface 222 near the body second end 204. A recess or cavity 216 is included to allow a hand to grip around the handle 210 and fingers to recess into the cavity 216.

FIG. 3 is a perspective view of another embodiment of a cleaning material 300 that is attached to a cleaning tool 400. In particular, in this embodiment, the cleaning material 300 is permanently secured and not intended to be removed from the cleaning tool 400. The cleaning tool 400 includes a body 420, and in this embodiment the cleaning tool 400 includes an optional handle 410. It is understood that the cleaning material may be a sheet permanently secured to the cleaning tool 400 or in some embodiment may be integrally formed with the cleaning tool 400.

The body 420 of the cleaning tool 400 has a first end 402, a second end 404 opposite the first end 402, a proximal region 406, in this embodiment referred to as an upper region, and a distal region 408, in this embodiment referred to as a bottom region. The body of the cleaning tool 400 includes a working surface 421. The working surface 421 supports the cleaning material 300 to make contact with the surface to be cleaned and perform the cleaning function.

In this embodiment, the working surface 421 includes planar surface 422 and a top face 424. The planar surface 422 extends from the body first end 402 to the body second end 404. The top face 424 extends from the body first end 402, however is generally opposite the planar surface 422. In this embodiment, the top face 424 is a planar surface, however it may be curved (convex or concave), textured, irregular, or other shape or configuration. The top face 424 and planar surface 422 converge together at the first end 402 of the cleaning tool 400 to form a tapered portion 426.

The cleaning tool 400 includes a handle 410. In this embodiment, the handle includes a first end 412 and a second end 414. The handle first end 412 is attached to the body 420, while the handle second end 414 remains unattached to the body 420. The handle first end 412 projects from the body 420, opposite the planar surface 422. It is understood that a variety of handle shapes, configurations, and placements may be used to allow a user to securely grip the cleaning tool 400.

The embodiment of cleaning tools 200 and 400 shown in FIGS. 1 and 3, respectively, include the cleaning material 100 and 300, respectively. It is understood that a variety of various shapes, sizes and configurations of the cleaning tool, supporting the cleaning material may be used. For example, the working surface may have planar, non-planar, uniformly curved, non-uniformly curved, stepped, irregular, or micro or macro textured surface(s) that support the cleaning material. Also, the working surface may be hard and rigid or may partially or entirely include a layer of deformable, conformable, or flexible material such as, for example, foam or sponge. Also, the cleaning materials shown include a variety of surfaces. It is understood that a single surface, such as, a planar, non-planar, or curved may be used. Therefore, the tapered region is not essential and is optional.

The convexly curved surface 222 of FIGS. 1 and 2 provides a particularly advantageous surface for supporting the cleaning material. To use the cleaning material, the user contacts the cleaning material with a surface to be cleaned. In one embodiment, the user wipes the cleaning material over the surface to be cleaned. With a convexly curved surface supporting the cleaning material, the user can “roll” the convexly curved surface 222 with the wiping motion over the surface to be cleaned. Such curved surface and wiping motion allows for many separate contact points on the cleaning material to make contact with the surface to be cleaned and maximize gathering and capturing debris, lint, and hair. A planar surface is suitable for the cleaning material, as shown in FIG. 3. However, by wiping a planar surface over a surface to be cleaned, often the debris, lint and hair will collect at a leading edge and have a “snowplowing” effect, minimizing the ability of the cleaning material to gather or capture debris, lint and hair.

As opposed to a convexly curved surface, other non-planar surfaces, having uniform, or random arrays of structures such as ridges, peaks, or bumps may be suitable in preventing snowplowing and enhancing gathering or capturing of debris, lint or hair. A spacer or glider may be included that provides a low friction surface to remove or recess the cleaning surface. The spacer or glider may be in the form of a fin, rail, bumps, ridges, or other protrusions. To further enhance this ability, it may be advantageous to also include a convexly curved surface along the direction of another axis.

A tapered region 226, 426 provides a particularly advantageous combination of surfaces for supporting the cleaning material. To use the cleaning material, the user contacts the cleaning material with a surface to be cleaned. In one embodiment, the user wipes the cleaning material over a surface to be cleaned. The tapered region creates a narrowed portion or point having a cleaning material in opposed direction available for cleaning. The tapered region provides a particularly desirable feature for gathering or capturing debris, lint, or hair in the crease of a chair, sofa, or the like, in the area where the back meets the seat.

The cleaning material 100, 300 may be any type of surface that is capable of gathering, capturing or removing debris, lint, or hair from a surface to be cleaned. The cleaning material 100, 300 may be removable from the working surface of the cleaning tool and intended to be reused or disposable. Alternatively, the cleaning material 100, 300 may be permanently secured to the working surface or may be integrally formed on the working surface 221, 421.

One suitable cleaning material is a directional fabric, such as disclosed in U.S. Pat. No. 6,901,622, or woven, knitted, or nonwoven fabric. Another suitable cleaning material is an adhesive surface. The adhesive surface may be integrally formed on the working surface of the cleaning tool or may be on a sheet placed over the working surface. For example, an adhesive sheet may be an adhesive coated film or paper. Another suitable cleaning material comprises protrusions such as hooks or stems. Either a hook or stem surface may be integrally formed on the working surface of the cleaning tool or may be on a sheet removable from or permanently secured to the working surface. The entire working surface may be covered with one type of cleaning material, such as shown in FIGS. 1, 2, and 3 where the working surface is shown as being covered with stems. However, the working surface may include a combination of different cleaning materials. For example, the cleaning material at the top face 224 may be of a different material than the cleaning material covering the other portions of the working surface 221.

If the cleaning material is in sheet form, the sheets may be individual sheet or may be a stack of sheets. Also, the sheet may be a sheet pulled from a continuous supply roll contained within the body of the cleaning tool. When a sheet is dirty, it can be removed and discarded. If the sheet is on a continuous supply roll, a cutting mechanism, such as a serrated edge, may be included to cut and remove the dirty sheet. Alternatively, the sheet on the supply roll may be perforated.

If the sheet is used in conjunction with a cleaning tool, the sheet or the cleaning tool will include an attachment mechanism for securing the sheet to the cleaning tool. During use a wiping motion causes frictional forces between the cleaning material and the surface to be cleaned. The attachment mechanism should form a secure connection between the cleaning material (sheet) and the working surface of the cleaning tool so that the cleaning material does not slip or remove from the working surface. In one embodiment, the cleaning material is secured to the working surface such that the cleaning material is securely placed under tension in the direction of intended wiping. For example, with reference to FIGS. 1 and 2, the attachment may be simply attached at the cleaning tool first end 202 and the cleaning tool second end 204 as the intended wiping direction is along axis A1. Additionally, a cleaning material that exhibits a slight elasticity has a better ability to be place under tension by securing opposing ends.

The back of the sheet may include an adhesive layer for permanent or releasable attachment to a cleaning tool. Alternatively, the cleaning tool may include the adhesive for permanent or releasable attachment to a sheet of a cleaning material. The back of the sheet may include a hook or loop layer for attachment to hooks on the cleaning tool. For example, a knitted or nonwoven material may be used as a loop for connection to hooks on the cleaning tool. The attachment mechanism is located at least at the body first end and the body second end for secure attachment of the sheet so that during a wiping motion the cleaning material remains securely connected to the cleaning tool. In one embodiment the entire area of contact between the cleaning material and the working surface includes an attachment mechanism. In another embodiment, such as where the attachment mechanism is a hook on the cleaning tool, the hooks are slightly recessed from the perimeter of the working surface to avoid the hooks from snagging or damaging the surface to be cleaned. Alternatively, the sheet may be larger in size than the working surface such that the sheet wraps up and around the working surface. An attachment mechanism may be appropriately located to securely hold the sheet up and around the working surface.

One particularly suitable material for the cleaning material includes a plurality of stems. Typically, stems are provided on and project from a backing, which is referred to as a stem web. U.S. Pat. Nos. 6,372,323; 6,610,382; and 6,904,615, the disclosures of which are herein incorporated by reference, disclose a stem web suitable as the cleaning material of the present invention and method of making a stem web. Unlike directional fabric, a stem web can be wiped across a surface in any direction and gather and capture debris, lint, or hair.

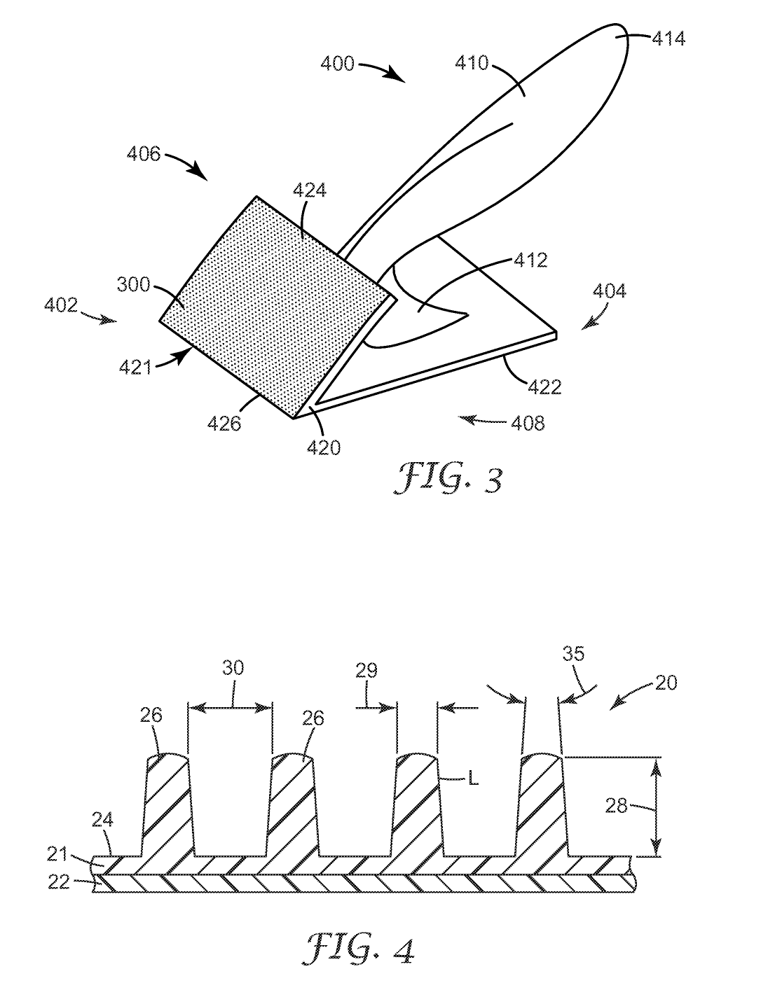

FIG. 4 shows a side-sectional view of one embodiment of a stem web 20 suitable as a cleaning material. In the embodiment shown in FIG. 4, the stem web 20 includes a backing layer 21 having a first surface 24 with an array of generally upstanding stems 26. The stems may be arranged in a regular or an irregular array. Various patterns of stems may be used, such as hexagonal, diagonal, sinusoidal, etc. The stems 26 are constructed at least in part of an elastomeric material. Preferably, the entire exterior surface of the stems 26 are an elastomeric material. In the embodiment of FIG. 4, the backing layer 21 is integrally formed with the stems 26 of an elastomeric material. Although the illustrated embodiment shows the stems 26 as being generally cylindrical, the sides of the stems 26 typically have a slight taper 35 to facilitate removal from the mold during formation. As shown in FIG. 4, the taper 35 is inward from the base to the tip of the stem. It is understood, that the stem may be constructed having a taper outward from the base to the tip of the stem. A variety of non-cylindrical shapes can also be utilized, such as truncated cones or pyramids, rectangles, hemispheres, squares, hexagon, octagon, gum drops, and the like.

A stem, for purposes of this disclosure, is distinguished from a hook. A stem is a protrusion that projects from a surface but does not form an interlocking fastening system like a hook may with a mating surface. Hooks generally have a overhang, or other portion that projects laterally from the main body of the hook to create the interlocking fastening system. A stem, alternatively, typically does not have a portion that projects laterally from the main body of the stem. As can be seen in the embodiment in FIG. 4, the stem 26 does not include a portion that projects laterally and instead has a linear side (as indicated by L as a line extending generally from the backing toward the tip of the stem).

Stems that are generally upstanding tend to optimize the performance of the cleaning material 100. The stems are kept upstanding by the stem diameter and the nature of the elastomeric material. As shown in the embodiment of FIG. 4, the upstanding stems angle relative to the backing is 90 degrees. However, an upstanding stems may be angled from 40 to 90 degrees relative to the backing. Additionally, the stems may be multi-angled such that different stems can angle in different directions. The stems typically have a height 28 in the range of about 0.2 mm to about 3 mm, preferably about 0.5 mm to about 1.5 mm. The separation or gap 30 between adjacent stems 26 is generally in the range of about 0.25 mm and about 2.5 mm and more typically in the range of about 0.4 mm to about 1.0 mm. This separation gap creates a percent of free volume that is volume within the stem web that is not occupied by the stems. The percent of free volume is typically from 60 to 98% of the stem web and more typically from 85 to 95%. The larger the free volume, the larger volume is available for loading with debris, lint or hair. The stems 26 have a maximum cross sectional dimension 29 of about 0.076 mm to about 0.76 mm. The stems 26 are arranged on the backing in a density of at least 20 per square centimeter, and more typically at least 50 per centimeter squared. The stem density is generally at most about 1000 per centimeter squared, more typically at most about 500 per centimeter squared.

The stems have an aspect ratio of at least 1.25, and preferably at least 1.5, and most preferably at least 2.0. Aspect ratio refers to the ratio of stem height to the maximum cross sectional dimension. For stems with a circular cross section, the maximum cross sectional dimension is the stem diameter. When the stems or pins are formed from an elastomeric material, the relatively small stem diameter enhances the soft nature of the stem web surface to the touch.

Suitable materials for the stem web include elastomers. The elastomer should have a Shore Hardness less than 105 A. In one embodiment, the elastomer has a Shore Hardness less than 85 A. Suitable materials include thermoplastic polyurethanes, polyvinyl chlorides, polyamides, polyimides, polyolefins (e.g. polyethylene and polypropylene), polyesters (e.g., polyethylene terephthalate), polystyrenes, nylons, acetals, block polymers (e.g., polystyrene materials with elastomeric segments, available from KRATON Polymers Company of Houston, Tex., under the designation KRATON™, polycarbonates, thermoplastic elastomers (e.g., polyolefin, polyester or nylon types) and copolymers and blends thereof. The thermoplastic material may also contain additives, including but not limited to fillers, fibers, antistatic agents, lubricants, wetting agents, foaming agents, surfactants, pigments, dyes, coupling agents, plasticizers, suspending agents, hydrophilic/hydrophobic additives, adhesives and tacky polymers, and the like.

The stems of the stem web provide a particularly desirable cleaning material because the stems project onto the surface to be cleaned to gather, capture, or collect debris, lint or hair from a surface. The free volume of the stem web provides open space for the debris, line or hair to become trapped in and held by the stem web. With a free volume from 60 to 98% of the stem web, a signification portion of the stem web is available for loading of the debris, lint or hair.

U.S. patent application Ser. No. ______ titled “Stem Web” filed on even date, the disclosure of which is herein incorporated by reference, discloses a stem web for use as the cleaning material. The stem web provides a surface for gathering, capturing, grabbing, and/or retaining material such as debris, lint, or hair when the stem web is contacted with the surface to be cleaned. In one embodiment, the stem web is wiped over the surface to be cleaned and is able to capture, grab and retain at least 60% wt., more typically at least 70% wt., of the debris, lint, or hair on the surface. Such things as fibers, lint, or hair can become entangled in the stems and therefore are more likely to be retained within the stem web. Other debris like food, dander, or dirt particle may be simply gathered by wiping by the stems. It understood that an adhesive, such as a pressure sensitive adhesive, may be included on the first surface 24 having the stems 26 to enhance the ability to retain collected debris, lint, or hair. The adhesive may be coated on the surface with the stems, may be co-extruded on the surface with the stems, or the adhesive may be incorporated into the polymer blend prior to forming the stems. When an adhesive is included, it is understood that a wiping motion is not necessary to pick up debris, lint, or hair and simply contact of the adhesive stem web with the surface to be cleaned may be sufficient to achieve pick-up.

The stem web provides a soft feel and conformable cleaning material that results in minimal damage when wiped repeatedly over a variety of surfaces, such as fabric and upholstery. Therefore, the stem can be repeatedly used to clean such things as clothing, furniture, carpeting to remove debris, lint or hair without excessive wear.

Secured to the backing 21 may be an optional layer 22 that may serve as a reinforcing layer or attachment layer. The layer 22 may impart increased tear resistance or tensile strength to the stem web. The layer 22 may serve as an attachment mechanism. For example, layer 22 may be an adhesive layer for adhesively securing the stem web 20 to a surface. Layer 22 may provide a hook or loop surface to attach to other hooks for securing the stem web 20 to another surface, like a cleaning tool. If layer 22 is serving as an attachment mechanism, layer 22 may be a woven, knitted, or nonwoven material that provides a loop for attachment to a hook. Layer 22 may be a foamed or a solid polymeric material. It may include a porous and/or absorbent layer, such as layers of fibrous material or fabric scrim which may be woven or nonwoven. A porous material is useful for absorbing moisture and/or directing moisture away from the stems. In one embodiment, the layer 22 includes a substantially inelastic layer to prevent necking or stretching of the stem web.

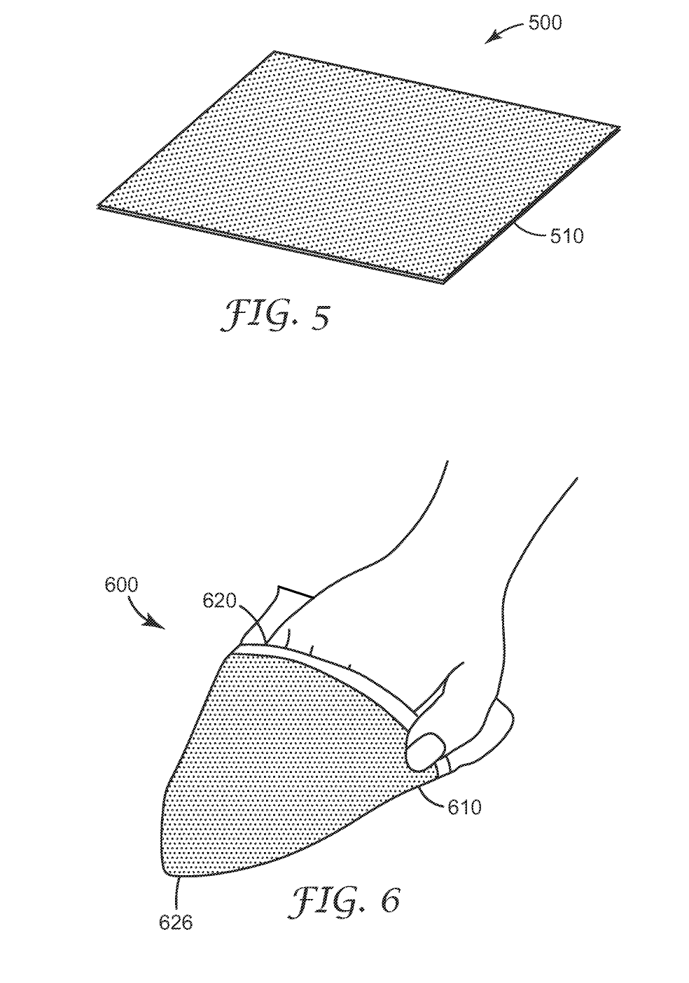

A stem web provides a cleaning material for gathering or removing debris, lint or hair from a surface to be cleaned. As shown by the cleaning material 500 in FIG. 5, the stem web may be provided in a sheet 510. The sheet 510 can be use independently to remove debris, lint or hair from a surface to be cleaned. The sheet 510 may be removable attached to a cleaning tool 200, such as shown in FIGS. 1 and 2.

As shown by the cleaning material 600 in FIG. 6, the stem web sheet may be formed into an envelope 610 having a pocket 620 for receiving a hand, as shown, or a cleaning tool. The stems of the stem web are on all of the outward facing surfaces of the envelope 610. As shown, the envelope 610 includes one open end providing access to the pocket 620 and one closed end creating a tapered portion 626. The tapered portion 626 provides a narrowed section that is accessible into corner areas and with the stem web on all outward facing surfaces of the envelope the tapered portion 626 is able to gather or remove debris, lint, or hair from upper and lower surfaces to be cleaned.

Alternatively, the envelope 610 may be provided as an open ended (two open ends) or partially closed ended (one open end) cylinder the stems of the stem web on all of the outward facing surfaces. Such a structure may be suitable for placement over a hand or over a tool, such as on a lint roller.

To use the cleaning material, the user will contact the cleaning material over a surface to be cleaned. Depending on the material chosen for the cleaning material, in one embodiment, the user will wipe the cleaning material over a surface to be cleaned. By wiping, the cleaning material remains relatively stationary with respect to the structure supporting the cleaning material, which may be a cleaning tool or a hand. The cleaning material gathers or captures debris, lint, or hair that is loose on the surface being cleaned. The gathered or captured debris, lint, or hair is removed from the surface being cleaning. In one embodiment, the cleaning material is able to remove the gathered debris, lint or hair. In another embodiment, a separate cleaning material is needed to remove the gathered debris, lint or hair.

Depending on the particular material of the cleaning material, the debris, lint, or hair may be securely trapped to the cleaning material. In such and embodiment, the cleaning material is disposable and following cleaning the cleaning material, along with the captured debris, lint, or hair, is discarded.

In another embodiment, following capture of the debris, lint, or hair, the cleaning material itself may be cleaned to remove some or all of the debris, lint, or hair. Then, the cleaning material may be reused for further cleaning applications. In such an embodiment, the cleaning material may be continually reused or may be disposable after one or several uses.

A stem web is particularly suitable for wiping across fabric or upholstered surfaces to gather or remove loose debris, lint, or hair. Because the stem web is not a hook, less damage to the fabric or upholstery occurs with repeated use. Due to the high amount of free volume, a stem web is able to gather or remove a large percentage of loose debris, lint, or hair from a surface.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A cleaning material comprising:
a backing including a first surface and a second surface;
an array of 20 to 1000 upstanding stems per square centimeter projecting from the first surface of the backing, wherein each stem has a height from 0.2 and 2.0 millimeters and a shore hardness less than 105 A;
wherein the first surface comprising the stems is wiped over a surface to be cleaned to gather debris, lint, or hair.

2. The cleaning sheet of claim 1, wherein the cleaning material is a sheet.

3. The cleaning sheet of claim 2, wherein the sheet is secured to a cleaning tool.

4. The cleaning sheet of claim 2, further comprising an attachment surface on the second surface of the cleaning tool for securing the cleaning sheet to a cleaning tool.

5. The cleaning sheet of claim 2, wherein the attachment surface comprises a loop or a hook for securing to hooks on the cleaning tool.

6. The cleaning sheet of claim 2, wherein the sheet forms a pocket such that the stems project outwardly from the pocket.

7. The cleaning sheet of claim 1, wherein the cleaning material is integrally formed on a cleaning tool.

8. A cleaning tool comprising:
a working surface having a cleaning material on at least a portion of the working surface, wherein the cleaning material includes an array of 20 to 1000 upstanding stems per square centimeter, wherein each stem has a height from 0.2 and 2.0 millimeters and a shore hardness less than 105 A, wherein the cleaning material is wiped over a surface to be cleaned to gather debris, lint, or hair.

9. The cleaning tool of claim 8, wherein the working surface includes a convexly curved surface.

10. The cleaning tool of claim 8, wherein the working surface includes a lower face and an upper face converging to a tapered portion.

11. The cleaning tool of claim 8, wherein the stems are integrally formed to the working surface of the cleaning tool.

12. The cleaning tool of claim 8, wherein the stems are provided on a first side of a backing to form a sheet that is removably attached to the working surface of the cleaning tool.

13. The cleaning tool of claim 12, wherein the backing includes an attachment surface on a second side of the backing, opposite the first side of the backing.

14. The cleaning tool of claim 13, wherein the attachment surface is a loop or hook for attachment to a hook on the working surface of the cleaning tool.

15. The cleaning tool of claim 8, further comprising a handle.

16. The cleaning tool of claim 15, wherein a first portion of the handle connects with a first end of the working surface and a second portion of the handle connects with a second end of the working surface.

17. A cleaning tool comprising:
a working surface having a lower face and an upper face converging to a tapered portion and having a cleaning material on at least a portion of the working surface, the cleaning material comprises an array of 20 to 1000 upstanding stems per square centimeter, wherein each stem has a height from 0.2 and 2.0 millimeters and a shore hardness less than 105 A; and
a handle for holding the cleaning tool.

18. The cleaning tool of claim 17, wherein the cleaning material is wiped over a surface to be cleaned to capture and collect debris, lint, or hair.

19. The cleaning tool of claim 17, wherein the lower face is an entirely convexly curved surface.

20. A cleaning tool comprising:
a working surface including a continuously convexly curved lower face and an upper face converging to a tapered portion;
a handle for holding the cleaning tool; and
a cleaning material removably secured to at least a portion of the working surface.

21. The cleaning tool of claim 20, wherein the cleaning material comprises an adhesive surface.

22. The cleaning tool of claim 20, wherein the cleaning material comprises a backing with an array of 20 to 1000 upstanding stems per square centimeter, wherein each stem has a height from 0.2 and 2.0 millimeters and a shore hardness less than 105 A.

23. A cleaning tool comprising:
a working surface including a first end and a second end and a continuously convexly curved lower face extending at least between the first end and the second end and an upper face converging to a tapered portion at the first end;
a handle including a first end adjacent the upper face and a second end adjacent the second end of the working surface; and
a cleaning material removably secured to the working surface, wherein the cleaning material comprises a backing with an array of 20 to 1000 upstanding stems per square centimeter, wherein each stem has a height from 0.2 and 2.0 millimeters and a shore hardness less than 105 A.

24. A method of cleaning a surface comprising:
providing a cleaning material having an array of 20 to 1000 upstanding stems per square centimeter, wherein each stem has a height from 0.2 and 2.0 millimeters and a shore hardness less than 105 A;
wiping the cleaning material over a surface to be cleaned;
capturing debris between the stems of the cleaning material.

25. The method of claim 24, wherein the surface to be cleaned is a woven, knitted, or nonwoven fabric and wherein the debris is hair.

26. The method of claim 24, comprising providing the cleaning material on a cleaning tool wherein the cleaning tool.
